(19) United States
(12) Patent Application Publication
(10) Pub. No.: US 2006/0106474 A1
(43) Pub. Date: May 18, 2006

(54) Computer aided design document generation and delivery system over distributed communication systems

(76) Inventors: Jon R. Mancuso, Catonsville, MD (US); Parthiv R. Amin, Ellicott City, MD (US); Charles A. Sakers, Elkridge, MD (US); Trevor D. Lewis, Crownsville, MD (US)

Correspondence Address: HARNESS, DICKEY & PIERCE, P.L.C., P.O. BOX 828, BLOOMFIELD HILLS, MI, 48303, US

(21) Appl. No.: 11/101,370

(22) Filed: Apr. 7, 2005

Related U.S. Application Data
(60) Provisional application No. 60/623,152, filed on Oct. 28, 2004.

(51) Int. Cl. G06F 19/00

(52) U.S. Cl. 700/97; 715/502

(57) ABSTRACT

A CAD drawing generation and delivery system comprises a CAD module that produces CAD documents. A CAD automation module receives design specifications including a selection of system components, an arrangement of the components, and a dimension relating to at least one of the components, and selectively operates the CAD module to generate one of the CAD drawings based on the design specifications. A server delivers the CAD drawing to a user at a remote location via a distributed communications system.

### CROSS-REFERENCE TO RELATED APPLICATIONS

This application claims the benefit of U.S. Provisional Application No. 60/623,152, filed on Oct. 28, 2004. The disclosure of the above application is incorporated herein by reference in their entirety.

### FIELD OF THE INVENTION

The present invention generally relates to the creation and distribution of computer aided design (CAD) drawings, and more particularly to a CAD document generation and delivery system for a distributed communications system.

### BACKGROUND OF THE INVENTION

Oftentimes, manufacturers sell one or more different components that are incorporated into device. Some of the components may require custom design for a particular application while other components may be off-the-shelf components. Through extensive experience, the manufacturer may have developed expertise designing the devices. The manufacturer may have developed design guidelines, formulas and/or other design parameters based on performance criteria. For example, a manufacturer may sell coupling devices that couple driving and driver shafts that require custom adapters, rigids, spacers and/or other custom coupling components. In addition to these designed components, the system may also include off the shelf components such as belts and fasteners.

As can be appreciated, the need for design services typically increases the cost of the device. The manufacturer and/or the purchaser may need to hire engineers to design the device for the particular application and/or engage the services of outside design professionals. In addition, the requirement for custom design services may also slow down the design and manufacturing process. The customer may also require additional equipment such as workstations, computer aided design (CAD) software and/or other expensive equipment. The location of this equipment may not be readily accessible in the vicinity of the particular application.

### SUMMARY OF THE INVENTION

A CAD drawing generation and delivery system comprises a CAD module that produces CAD documents. A CAD automation module receives design specifications including a selection of system components, an arrangement of the components, and a dimension relating to at least one of the components, and selectively operates the CAD module to generate one of the CAD drawings based on the design specifications. A server delivers the CAD drawing to a user at a remote location via a distributed communications system.

In other features, a selection and design module generates the design specifications based on data provided by the user over the distributed communications system. The selection and design module performs automatic selection of one or more system components based on the data provided by the user over the communications system. The selection and design module queries the user for values of predefined factors relating to operating conditions of the system.

A method for generating and delivering CAD documents comprises generating user screens that solicit design specifications from a remote user; receiving the design specifications including a selection of system components, an arrangement of the components, and a dimension of at least one of the components; automatically operating a CAD module to generate a CAD document based on the design specifications; and delivering the CAD document to a user at a remote location via a distributed communications system.

In other features, the method includes performing automatic selection of one or more system components based on the data provided by the user over the distributed communications system. The method includes obtaining design data from the user over the distributed communications system, wherein the design data includes operating conditions for components of the system. The method includes obtaining design data from the user over the distributed communications system, wherein the design data includes operating conditions for components of the system; automatically selecting system components based on the design data; and including a textual list of the system components in the CAD documents. The method includes identifying a plurality of appropriate system designs based on user input obtained over the distributed communications system; communicating the plurality of appropriate system designs to the user over the distributed communications system; and receiving a selection of exactly one appropriate system design from the user over the communications system.

In still other features, the method includes communicating a plurality of options for one or more of supplementing and modifying the appropriate system design to the user over the distributed communications system; receiving selections exercising options to one or more of supplement and modify the appropriate system design from the user over the distributed communications system; and generating the design specifications based on the appropriate system design as one or more of supplemented and modified in accordance with the selections.

A design system for designing devices remotely over a distributed communications system comprises a remote computer including a browser that communicates with the distributed communications system. A web server communicates with the browser over the distributed communications system. A database stores data. A computer aided design (CAD) module generates CAD documents. A design module communicates with the web server, the CAD module and the web server, outputs user interface screens to the remote computer for selecting the device and for specifying design parameters of the device, and generates a CAD specification file for the device based on data stored in the database and the selected design parameters. The CAD module automatically generates CAD documents based on the CAD specification file. At least one of the CAD documents is transmitted over the distributed communications system to the remote computer.

In other features, the device includes first components that are designed based on the design parameters and second components that include off-the-shelf components. The CAD module comprises a CAD tool operable to produce a CAD drawing and a CAD automation module that receives design specifications including a selection of system components, an arrangement of the components, and dimensions of the components, and that selectively operates the CAD tool to generate a CAD drawing based on the design specifications.

In yet other features, the design module includes a selection and design module that generates design specifications based on data provided by the user over the distributed communications system. The configurator tool performs automatic selection of one or more system components based on the data provided by the user over the distributed communications system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a distributed computer aided design (CAD) document generation and delivery system according to the present invention;

FIG. 2 is a more detailed block diagram illustrating portions of the CAD document generation and delivery system according to the present invention;

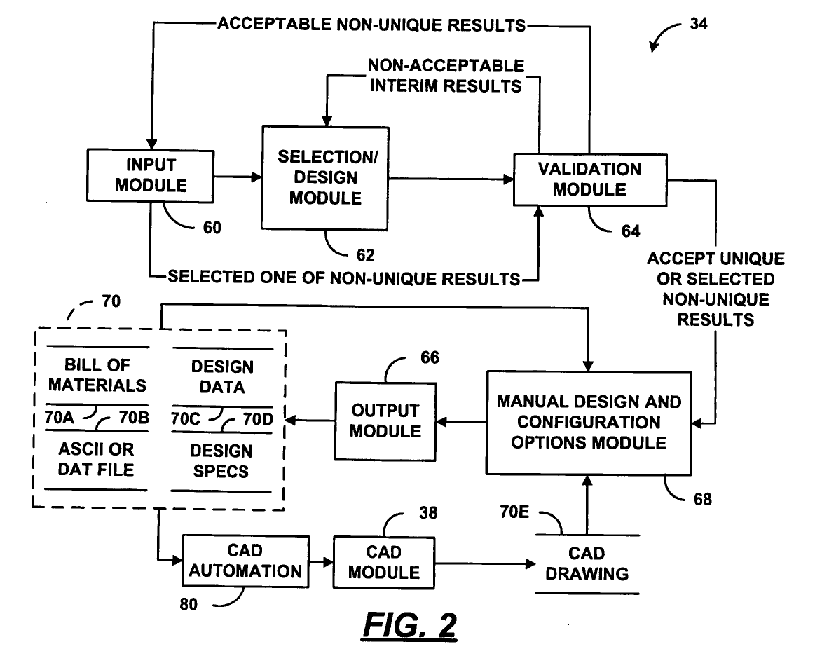

FIG. 3 is a flow diagram illustrating CAD document generation and delivery method according to the present invention; and

FIG. 4 is an entity relationship diagram illustrating provision of user interface components to users in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify similar elements.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. As used herein, the term CAD document refers to 2-D and/or 3-D CAD drawings and/or related documents. 2-D drawings in CAD systems typically refer to a view that can be dimensioned or detailed. 3-D CAD systems generate many document types including but not limited to models, parts, assemblies, drawings, etc.

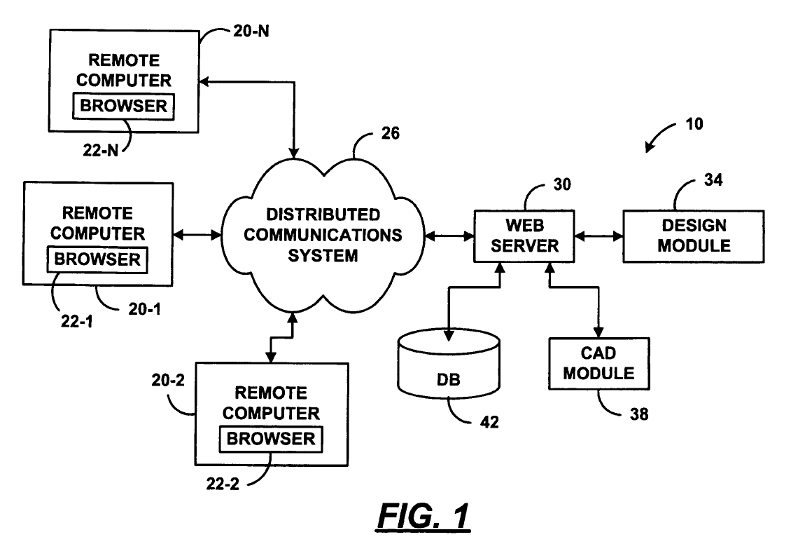

Turning now to FIG. 1, a CAD document generation and distribution system 10 according to the present invention for remotely generating CAD documents is shown. Computers 20-1, 20-2, . . . and 20-N (collectively referred to as computers 20) include browsers 22-1, 22-2, . . . and 22-N, respectively that manage communications between the computers 20 and other computers and servers connected to a distributed communications system (DCS) 26. The computers 20-1, 20-2, . . . and 20-N need not have any local programs that are specific to the CAD document generation and delivery system of the present invention other than the browsers 22-1, 22-2, . . . and 22-N, respectively, (which are collectively referred to as browsers 22). The DCS 26 can include the Internet, an intranet, and extranet or any suitable other transmission medium, wired or wireless, that uses Internet Protocol, narrowcast, broadcast, and/or any two-way communications technique.

The computers 20 communicate with a remote server 30 via the DCS 26. The remote server 30, in turn, communicates with a design module 34, a CAD module 38 and a database 42. As can be appreciated, the design module 34 generates user screens that are output to the browsers 22 of the computers 20. The user interface screens are used to collect pertinent information from the remote user. Via the user selection screens, the expert module 42 collects information including but not limited to device type selection, application information, design parameters, arrangement information, performance parameters, modifications, etc. The design module 34 selectively accesses the database 42 for data that is required to populate the user selection screens. The design module 34 also incorporates design guidelines into an expert system to allow design verification and/or to limit selections to those that will meet the design specifications.

Once the selection, validation and modification process is complete, the design module 34 generates a specification file that is output to the CAD module 38. Upon receiving the specification file, the CAD module 38 generates CAD documents. Some or all of the CAD documents are transmitted to a respective one of the computers 20 via the web server 30 and the DCS 26.

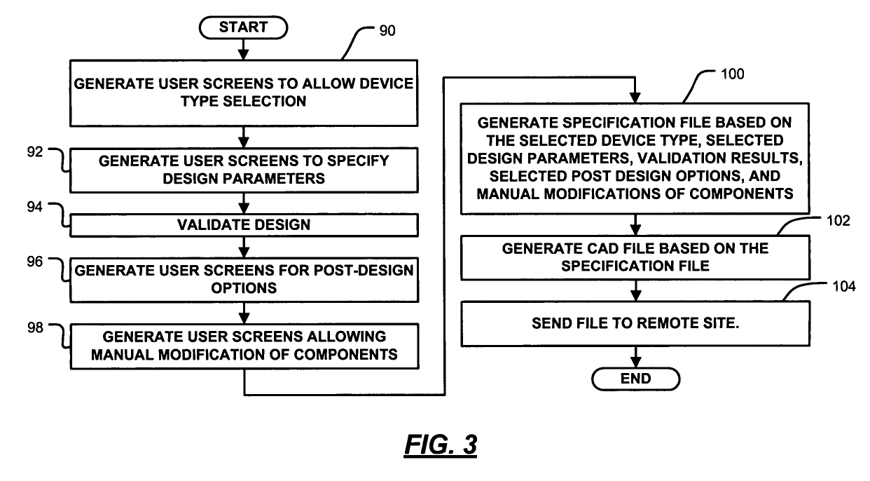

Turning now to FIG. 3, the design module 34 according to some implementations of the present invention includes an input module 60 that outputs user interface screens to elicit user input. When completed by the user, the input module 60 also receives the user input including one or more design parameters and/or user selections. A selection and design module 62 generates the user interface screens that allow selection of a device type, specification of design parameters of device components, etc. as will be described further below. An output module 66 generates output 70 in one or more forms. For example, the output may include a bill of materials 70A, an ASCII or DAT file 70B, design data 70C, a design specification file 70D, and/or other CAD.

In some embodiments, the design system 34 includes a validation module 64 that validates the design. The validation includes a determination of whether the selected parameters meet the performance specifications. If there are multiple configurations that will meet the performance specifications, the input module 60 prompts the user to select one of the configurations. If there are no acceptable results, the design is considered to be a non-acceptable interim result. The user is afforded the opportunity to alter the design for a further validation attempt. Thus, the validation includes generation of validation results indicating whether a design is valid. Successful operation results in a validated design, whether unique or non-unique. Accordingly, the output module 66 generates the design specification file 70 based the selected and validated design.

Additional or alternative embodiments further include a manual design modification and configuration options module 68, which allows the user to select options that can be added to the design, and/or to manually alter individual components of the design. Accordingly, the validated design can be supplemented and modified by user input selections and/or parameters. Where applicable, output module 66 generates the design specification file 70 based on the options exercised and/or modifications made by the user to the design, so that the design specification file 70D reflects the modifications accordingly.

The design specification file 70D produced by the output module 66 is generated from active, current design data file 70C, which can alternatively or additionally be saved as its own file. Other outputs 70 that can be produced by output module 66 include a bill of materials 70A for all components of the designed coupling, an ASCII or .DAT file 70B describing the designed coupling and/or other CAD documents. In some embodiments, the ASCII or .DAT file 70B serves as a user readable record of the specification file 70D. It can additionally or alternatively serve as a record of user defined data that references other files relating to the coupling design. The specification file 70D may be in purely machine readable form, and especially formatted for automated input to a computer aided design tool 38 via a CAD automation module 80.

The CAD automation module 80 further includes software that feeds data from output 66 into CAD module 38 to produce a CAD drawing file 70E. It should be readily understood that CAD automation module 80 can be viewed as part of the output module 66, and the CAD drawing file 70E thus produced can be viewed as part of the output 70. It should be readily understood that a single document can alternatively or additionally be created that takes the form of a CAD drawing 70E with one or more parts of the bill of material 70A, design data 70C, design specs 70D, and user supplied data of file 70B included in tables or other readouts of the drawing 70E.

Turning now to FIG. 3, the CAD document generation and delivery method according to the present invention begins with a device type selection based on user input parameters at step 90. The device type can be selected based on a user-defined application. Alternatively or additionally, the device type can be selected based user input parameters such as performance specifications. If only one class of devices is available, this step can be omitted. Still other input values will be apparent.

In step 92, the user inputs and/or selects parameters specifying design parameters of the device or system. In step 94, the design is validated. In step 96, the user is allowed to supplement or alter the valid design. For example, after a valid design has been obtained in step 94, the user is allowed to select one or more post design options in step 96. Also, the user is permitted to manually modify one or more components of the design in step 98 by setting new values for component characteristics. If desired, the ability to set new values for a component can be constrained according to component modifiability.

Once the user is satisfied with the design, the user can generate a specification file in step 100 based on the data obtained in steps 90-98. The user can also generate a computer aided design (CAD) drawing file based on the specification file in step 102. Steps 100 and 102 may also be performed immediately upon design completion. Various file formats may be provided for the user's convenience. The CAD documents can be delivered to the user over the DCS 26. As a result, the user is able to obtain information for obtaining materials for creating the coupling along with a CAD document for doing so in a facilitated manner.

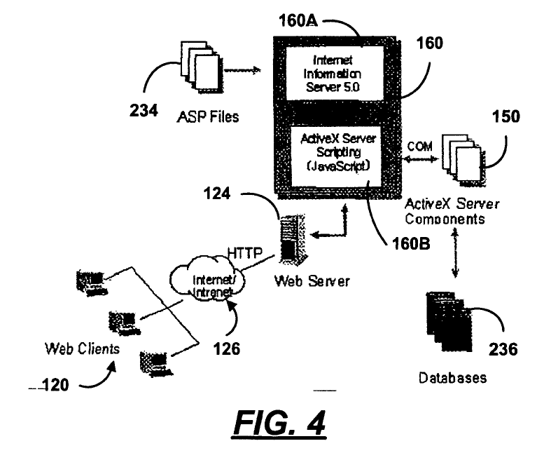

Turning now to FIG. 4, an entity relationship diagram illustrates one implementation of the user interface components described above that can be accessed and employed by a user. In particular, web clients 120 access web server 124 over DCS 126, such as the Internet. Server 124 accesses application service provider (ASP) files 128 and databases 130 to obtain active server components 150. In some implementations, the active server components 150 are Active X server components. In some implementations, the components are supplied in an ASP page 160 using Internet Information Server 5.0 160A and Active X Server Scripting 160B. In some implementations, the databases are ODBC compliant databases.

In use, a user accesses the design system ASP page on an IIS-based web site through the web browser. The user is able to view the page if the user has the necessary access rights. The business logic is encapsulated into business service objects. These objects are implemented separately as ActiveX controls. They are responsible for implementing all actions required by the business processes like data/image extraction, mathematical calculations and updating databases with new data.

The ASP page 160 has a mixture of HTML and Java Script code. Creation of drawings and saving of drawings are accomplished using server-side scripting. The ActiveX (COM Automation) interface in AutoCAD software is used to generate the necessary AutoCAD drawings. The plug-in, such as AutoCAD Express Viewer is used to view the AutoCAD drawings.

Exemplary systems include coupling design automation such as that disclosed in “Local and Distributed Systems for Coupling Automation Design”, U.S. Patent Application Ser. No. 60/623,152, filed on Oct. 28, 2004, which is hereby incorporated by reference in its entirety.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A CAD drawing generation and delivery system, comprising:
a CAD module that produces CAD documents;
a CAD automation module that receives design specifications including a selection of system components, an arrangement of the components, and a dimension relating to at least one of the components, and that selectively operates the CAD module to generate one of the CAD drawings based on the design specifications; and
a server that delivers the CAD drawing to a user at a remote location via a distributed communications system.

2. The system of claim 1 further comprising a selection and design module that generates the design specifications based on data provided by the user over the distributed communications system.

3. The system of claim 2 wherein the selection and design module performs automatic selection of one or more system components based on the data provided by the user over the communications system.

4. The system of claim 3 wherein the selection and design module queries the user for values of predefined factors relating to operating conditions of the system.

5. A method for generating and delivering CAD documents, comprising:
generating user screens that solicit design specifications from a remote user;
receiving said design specifications including a selection of system components, an arrangement of the components, and a dimension of at least one of the components;
automatically operating a CAD module to generate a CAD document based on the design specifications; and
delivering the CAD document to a user at a remote location via a distributed communications system.

6. The method of claim 5 further comprising performing automatic selection of one or more system components based on the data provided by the user over the distributed communications system.

7. The method of claim 5 further comprising obtaining design data from the user over the distributed communications system, wherein the design data includes operating conditions for components of the system.

8. The method of claim 5 further comprising:
obtaining design data from the user over the distributed communications system, wherein the design data includes operating conditions for components of the system;
automatically selecting system components based on the design data; and
including a textual list of the system components in the CAD documents.

9. The method of claim 5 further comprising:
identifying a plurality of appropriate system designs based on user input obtained over the distributed communications system;
communicating the plurality of appropriate system designs to the user over the distributed communications system; and
receiving a selection of exactly one appropriate system design from the user over the communications system.

10. The method of claim 9 further comprising:
communicating a plurality of options for one or more of supplementing and modifying the appropriate system design to the user over the distributed communications system;
receiving selections exercising options to one or more of supplement and modify the appropriate system design from the user over the distributed communications system; and
generating the design specifications based on the appropriate system design as one or more of supplemented and modified in accordance with the selections.

11. A design system for designing devices remotely over a distributed communications system, comprising:
a remote computer including a browser that communicates with the distributed communications system;
a web server that communicates with said browser over said distributed communications system;
a database that stores data;
a computer aided design (CAD) module that generates CAD documents; and
a design module that communicates with said web server, said CAD module and said web server, that outputs user interface screens to said remote computer for selecting said device and for specifying design parameters of said device, and that generates a CAD specification file for said device based on data stored in said database and said selected design parameters, wherein said CAD module automatically generates CAD documents based on said CAD specification file, and wherein at least one of said CAD documents is transmitted over said distributed communications system to said remote computer.

12. The design system of claim 11 wherein said device includes first components that are designed based on said design parameters and second components that include off-the-shelf components.

13. The design system of claim 11 wherein said CAD module comprises:
a CAD tool operable to produce a CAD drawing;
a CAD automation module that receives design specifications including a selection of system components, an arrangement of the components, and dimensions of the components, and that selectively operates the CAD tool to generate a CAD drawing based on the design specifications.

14. The system of claim 1 1 wherein said design module includes a selection and design module that generates design specifications based on data provided by the user over the distributed communications system.

15. The system of claim 14 wherein said configurator tool performs automatic selection of one or more system components based on the data provided by the user over the distributed communications system.
